(19) United States
(12) Patent Application Publication
(10) Pub. No.: US 2010/0064357 A1
(43) Pub. Date: Mar. 11, 2010

(54) Business Processing System Combining Human Workflow, Distributed Events, And Automated Processes

(76) Inventors: Kerstin Baird, Portland, OR (US); Tim Buss, Novato, CA (US); Brian Carroll, Hillsboro, OR (US); Ali Kheirolomoom, Pleasanton, CA (US); Rohit Jainendra, San Francisco, CA (US); Kartik Raghavan, Oakland, CA (US)

Correspondence Address: HICKMAN PALERMO TRUONG & BECKER, LLP, 2055 GATEWAY PLACE, SUITE 550, SAN JOSE, CA, 95110, US

(21) Appl. No.: 12/207,477

(22) Filed: Sep. 9, 2008

(51) Int. Cl. H04L 9/32; G06F 9/46

(52) U.S. Cl. 726/6; 718/102

(57) ABSTRACT

Techniques are provided for designing, deploying, and executing mashups that integrate human workflows with automated processes. In an example embodiment, a system for executing mashups comprises a human interaction module, an event manager module, and a process orchestration module. The human interaction module is configured to receive user input while a human workflow included in a mashup is being executed, and to raise an event in response to the user input. The event manager module is configured to: receive the event from the human interaction module; based on the event, identify a particular automated process from one or more automated processes that are included in the mashup; and invoke the process orchestration module to execute the particular automated process based on the event. The process orchestration module is configured to execute the particular automated process in response to being invoked by the event manager module.

### FIELD OF THE INVENTION

This invention relates generally to software development, delivery, and execution.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

From the perspective of software operation, human workflows are very different from automated processes. Human workflows typically involve state transitions that take place in response to human interaction, while automated processes typically involve activities that are automatically performed at one or more computer systems without any human interactions. This operational difference has made it challenging to develop environments for executing software products that combine human workflows and automated processes. It is even more challenging to develop environments for executing such software products when the software products are designed to rely on data and responses from external or third-party sources over which the software product developers have no control.

One example of such software products are mashups. In general, a mashup is a composite application that is operable to integrate and present data provided by one or more external sources such as, for example, web services. While mashups may allow for implementing human workflows and automated processes separately from each other, developing mashups that integrate human workflows and automated processes has proved to be difficult. This is at least in part because of the nature of mashups (which rely extensively on access to external services over which mashup developers have no control) and because of the operational difference between human workflows and automated processes (which makes the development of mashup execution environments very difficult).

For example, as means for providing interoperability between human workflows and automated processes, most if not all approaches for developing mashups provide for hard-coding in the mashups any necessary information that integrates the human workflows with the automated processes. Hard-coding such information may include hard-coding calls to known servers and services and writing requests and other messages in various pre-determined structures, such as shared queues, stacks, and other inter-process communication mechanisms.

One disadvantage of these approaches for developing mashups is that they lack flexible mechanisms for providing interoperability between human workflows and automated processes. In these approaches, the integration between the human workflows and the automated processes is hard-coded at the time the mashup is designed and developed. For example, each portion of a human workflow or an automated process that interacts with any other portions needs to know in advance what service or server to call and what data to access or request. This, however, severely limits the complexity of the human workflows and automated processes that can be implemented in a mashup. As a result, the business logic that the mashup can provide is limited, and the overall business value of the mashup is reduced.

Another disadvantage of these approaches for developing mashups is that they require technically sophisticated users, such as software developers, to design and develop the mashups. Because these approaches require all information for integrating human workflows and automated processes to be hard-coded at design and development time, only software developers would be able to develop mashups that integrate human workflows and automated processes. However, fairly unsophisticated software users, such as business users, are well-suited to design and develop mashups by using easy-to-use, drag-and-drop development tools. Thus, even if a business user uses such a development tool to design a mashup, that mashup would not be able to integrate human workflows and automated processes because such integration would require technical knowledge which the business user is unlikely to have.

Yet another disadvantage of these approaches for developing mashups is that they require an on-premise installation, in which an execution environment for executing the mashups is under the control of a single entity or enterprise. The on-premise installation of the mashup execution environment, however, limits the ability of vendors to deliver mashups to a wide variety of subscribers. For example, mashups developed according to these approaches cannot be executed or provided in an On-Demand delivery of software paradigm. On-Demand delivery of software (also known as Software as a Service, or SaaS) refers to a software delivery model where software vendors provide software capabilities on a subscription basis through software services, which are hosted by the vendors and which can be accessed by various subscribers when needed. For example, SaaS applications may be delivered to subscribers through web browsers, thus allowing the software vendors to host the underlying services and to benefit from the economies of scale. The SaaS model provides a good environment for the delivery and use of various types of mashups because mashups typically interact with external services, many of which can be provided on-demand.

Further, the on-premise installation of the mashup execution environment (e.g., behind a firewall in an enterprise domain) may allow for tracking the identities of the end users that use the mashup. However, the identity of users cannot be easily tracked in a SaaS environment because SaaS-enabled mashups may access different external services each of which may have its own authentication and user-identification mechanism. This problem is especially acute for SaaS-enabled mashups that integrate human workflows and automated processes. For example, it is very difficult to track the identity of end users that provide input to a human workflow in a SaaS-enabled mashup, and tracking user identity across automated processes that interact with the human workflow would be close to impossible.

### BRIEF DESCRIPTION OF THE DRAWINGS

In the figures of the accompanying drawings like reference numerals refer to similar elements.

FIG. 1 is a block diagram that illustrates an operational context according to an example embodiment.

FIG. 2 is a flow diagram that illustrates a method for designing mashups according to an example embodiment.

FIG. 3 is a flow diagram that illustrates a method for deploying mashups according to an example embodiment.

FIG. 4A is a block diagram that illustrates an execution environment system according to an example embodiment.

FIG. 4B is a flow diagram that illustrates a method for executing mashups according to an example embodiment.

FIG. 5 is a block diagram that illustrates a runtime operational example according to one embodiment.

FIG. 6 is a block diagram that illustrates an example computer system on which embodiments may be implemented.

### DETAILED DESCRIPTION

In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention. Various aspects of the invention are described hereinafter in the following sections:
I. OVERVIEW
II. DESIGNING MASHUPS THAT INTEGRATE HUMAN WORKFLOWS AND AUTOMATED PROCESSES
III. DEPLOYING MASHUPS THAT INTEGRATE HUMAN WORKFLOWS AND AUTOMATED PROCESSES
IV. RUNTIME EXECUTION ENVIRONMENT
V. RUNTIME OPERATIONAL EXAMPLE
VI. IMPLEMENTATION MECHANISMS

### I. Overview

Techniques are described herein for designing, deploying, and executing mashups. As used herein, “mashup” refers to a composite software application that is operable to integrate and present functionalities and data that are provided by one or more external services. Different types of mashups include, without limitation, presentation mashups, data mashups, and business mashups. A presentation mashup is operable to integrate data from one or more external sources, such as web services, and to present the integrated data to a user in a graphical user interface (GUI). An example of a presentation mashup is a mashup that is operable to combine real estate listings provided by a home listing service with the corresponding map locations provided by a map service. A data mashup is typically operable to combine and integrate data of similar types that are provided by multiple different services. An example of a data mashup is a mashup that is operable to combine the data from multiple RSS feeds into a single feed. A business mashup is operable to combine and present data from one or more external services and to integrate the data with specific program logic. An example of a business mashup is a mashup operable to integrate product prices received from one or more web services with a graphical user interface that allows a business manager to approve or reject a discount off the prices for certain products.

Regardless of its type, a mashup may combine one or more human workflows with one or more automated processes. “Human workflow” refers to a sequence of operations, where the operations may be performed in response to input provided by one or more end users of the mashup. “Automated process” refers to a sequence of operations, where the operations are performed automatically without requiring or being responsive to user input or to other types of human interactions.

In an example embodiment, the techniques described herein for designing a mashup provide for generating a definition for the mashup based on design information that specifies: design elements that define a human workflow in the mashup; one or more automated processes in the mashup; and one or more events, where a particular event associates a particular design element with a particular automated process. The generated definition of the mashup logically integrates the design elements of the human workflow with the one or more automated processes based on the one or more events, but does not bind the design elements, the one or more automated processes, and the one or more events to execution components that are operable to execute the mashup.

In an example embodiment, the techniques described herein for deploying a mashup provide for generating deployment information that binds each of the human workflows and the automated processes included in the mashup to one or more execution components. The deployment information is generated based on a logical definition of the mashup and on configuration information that specifies the one or more execution components that are operable to execute the human workflows and the automated processes. The mashup is then deployed to the one or more execution components based on the deployment information.

In an example embodiment, the techniques described herein for executing a mashup provide for an execution environment comprising a system that is configured to integrate, at runtime, any human workflow(s) and automated process(es) that are included in a mashup. During runtime when the mashup is being executed at the system, the system and/or components thereof are operable at least to: receive events that are raised by the human workflow(s) and/or the automated process(es) included in the mashup; resolve an event by at least identifying which automated process and/or which human workflow operation to invoke in response to that event; and execute the identified automated process and/or the identified human workflow operation in response to the event. In some implementations, the system is configured to provide the mashups and/or the system components that execute them as one or more SaaS services. In addition, or instead of, in some implementations the system provides one or more components that are configured to perform authentication and authorization of mashup end users and to generate corresponding identity tokens. Thereafter, during runtime the identity tokens may be passed in (or along with) the events that are raised by the various mashup elements while the mashup is being executed at the system, thus allowing the propagation of end user identity to the various human workflows and automated processes of the mashups.

In this manner, the techniques described herein provide for de-coupling of mashup design from mashup deployment and from mashup execution. This allows technologically unsophisticated users such as business users to design mashups, including mashups that integrate human workflows and automated processes, without having the technical knowledge necessary for setting up and configuring the mashups for execution.

Further, by using distributed events to provide interoperability between human workflows and automated processes, the techniques described herein allow for designing and executing of mashups that implement arbitrarily complex business logic. In addition, since the events raised by the human workflows and the automated processes are resolved at runtime during the execution of the mashups, the techniques described herein avoid the need for hard-coding any service calls and other requests into the mashups at the time mashups are designed and developed. Finally, by providing the mashups and/or the system components that execute them as one or more SaaS services and by providing system components for authenticating and authorizing mashup end users, the techniques described herein allow for avoiding the disadvantages of on-premise installation of the mashup execution environment and for letting software vendors to fully avail themselves of the benefits of the SaaS model for delivery and use of software.

It is noted that the techniques described herein may be implemented in various embodiments including, but not limited to, one or more computer-implemented methods that are executed by one or more computer systems, one or more computer apparatuses, one or more integral or distributed systems, and one or more computer-readable storage media storing sequences of instructions that can be executed by one or more processors.

II. Designing Mashups that Integrate Human Workflows and Automated Processes

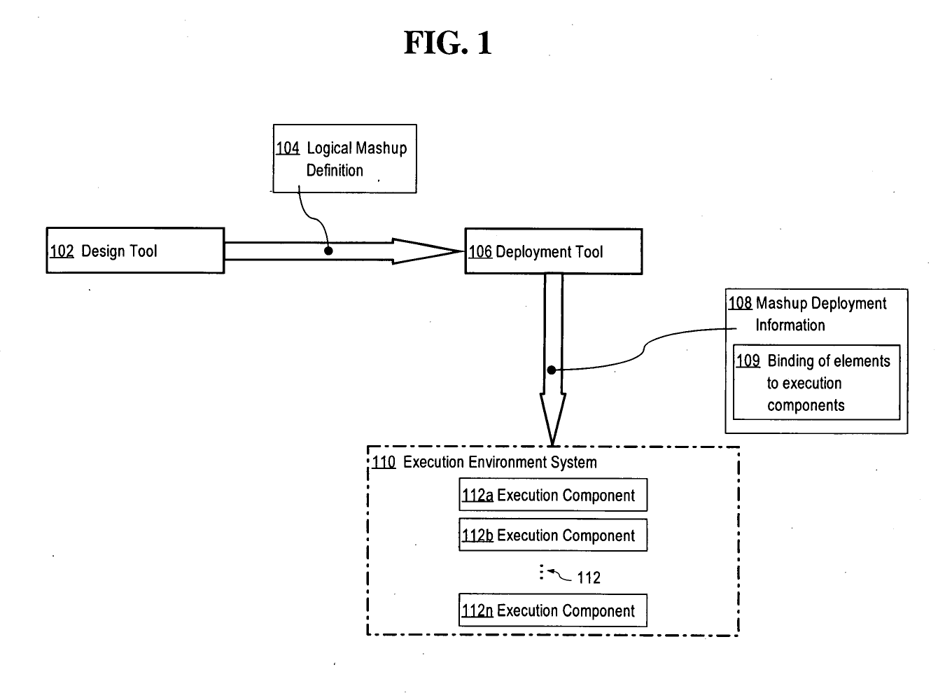

FIG. 1 is a block diagram that illustrates an example operational context in which the techniques described herein for designing, deploying, and executing of mashups may be implemented. The example operational context comprises design tool 102 that may be used by users to design and develop mashups, deployment tool 106 that may be used to deploy mashups, and execution environment system 110 that is operable to execute the mashups deployed through deployment tool 106. Execution environment system 110 may include one or more execution components 112 such as, for example, execution components 112a, 112b, and 112n. As used herein, “execution component” refers to a combination of software and/or hardware elements which, when executed, may be allocated computational resources, such as memory, CPU time, and/or disk storage space in order to execute a mashup or any portions thereof. Examples of execution components include, but are not limited to, servers, services, virtual machines, daemons, and any other computer system processes that are allocated computing resources and are configured to execute mashups and/or portions thereof. In various embodiments, the different execution components of execution environment system 110 may be included on same computer system or hardware platform, on a cluster of interconnected computer systems or hardware platforms, or may be distributed on different computer systems or hardware platforms over a network.

Design tool 102 may be implemented as a set of instructions which, when executed by one or more processors, are operable to allow a user to design a mashup. For example, design tool 102 may be operable to provide the GUI interfaces and other forms, as well as the underlying logic, through which the user may provide design information that defines or modifies a mashup and the design elements included therein. The GUI interfaces and forms, as well as the underlying logic, may be included in a visual design tool that allows the user to drag-and-drop various design elements into a work area, to interconnect the various design elements by visually designing an orchestration that combines and integrates the design elements into one or more human workflows, and/or to integrate the one or more human workflows with one or more automated processes. In various embodiments, design tool 102 may be implemented as a software program code that may be executable in various ways, including but not limited to, as a standalone application, as a portion of a client-server application, and as a SaaS application.

As used herein, “design element” refers to a software element that is defined and used in a mashup. Examples of design elements include, but are not limited to: contracts that define the input/output parameters of external services, such as Web Services Description Language (WSDL) definitions for web services; GUIs and GUI elements (such as buttons, drop-down boxes, text boxes, list boxes, etc.) that are operable to receive input from end users when the mashup is executed; forms that are operable to receive user input or to display information to end users; sets of source code instructions that may be compiled prior to deploying the mashup for execution; instructions in extensible transformation languages, such as XSLT or CSS templates; and event definitions that define events that are included in, and integrate, human workflows and automated processes included in the mashup. The techniques described herein are not limited to using any particular types of design elements, and for this reason the examples of mashup design elements provided herein are to be regarded in an illustrative rather than a restrictive sense.

In operation, design tool 102 is configured to receive from a user, who is designing a mashup, design information that specifies one or more of: design elements that define a human workflow in the mashup; one or more automated processes in the mashup; and one or more events, where a particular event associates a particular design element with a particular automated process. When the user completes designing the mashup, logical mashup definition 104 of the mashup is generated by design tool 102. For example, logical mashup definition 104 may be automatically generated by design tool 102 in response to the user saving the mashup. Alternatively, or in addition to, logical mashup definition 104 may be automatically generated by design tool 102 in response to user input that specifically requests the definition to be generated. After being generated, logical mashup definition 104 may be transferred or send to a deployment tool, such as deployment tool 106.

Logical mashup definition 104 for a given mashup logically integrates the design elements of the human workflow with the one or more automated processes based on the one or more events. Logical mashup definition 104, however, does not bind the design elements, the one or more automated processes, and the one or more events to execution components that are operable to execute the mashup.

In various embodiments, a logical mashup definition for a given mashup may be implemented as a set of data in various formats. For example, in some embodiments a logical mashup definition may be implemented as a set of files in an extensible markup language (XML) format. In some embodiments, a logical mashup definition may be implemented as one or more data objects that are stored in one or more repositories such as a directory. In some embodiments, a logical mashup definition may be implemented as one or more data records in one or more files or databases. In some embodiments, a logical mashup definition may be implemented as a data stream that is generated from design information and is transmitted to a receiving application such as, for example, deployment tool 106. Thus, the techniques described herein for designing mashups are not limited to any particular type or format in which logical mashup definitions of mashups are generated and stored.

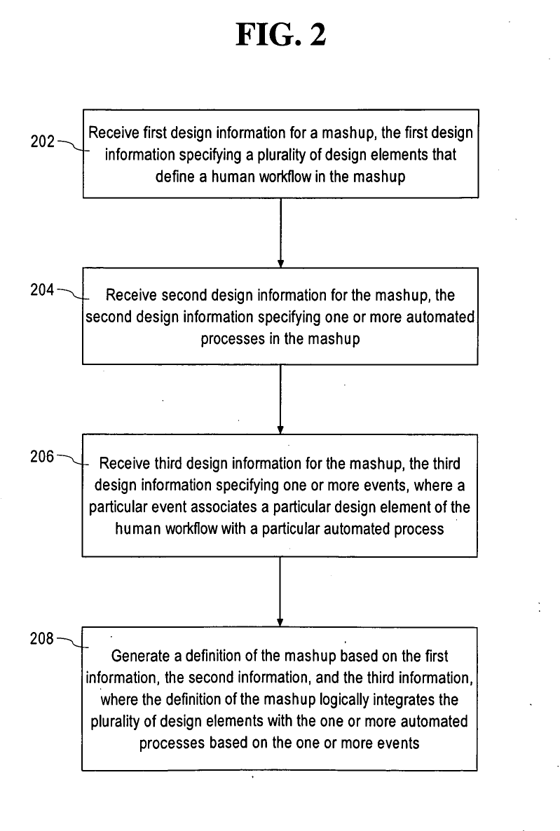

FIG. 2 is a flow diagram that illustrates a method for designing mashups according to an example embodiment.

In step 202, a design tool receives first design information for a mashup. The first design information specifies a plurality of design elements that define a human workflow in the mashup. In step 204, the design tool receives second design information for the mashup. The second design information specifies one or more automated processes that are included in the mashup. In step 206, the design tool receives third design information for the mashup. The third design information specifies one or more events. Each event associates a particular design element of the human workflow with a particular automated process.

As used herein, “event” refers to a set of data that is generated in response to the completion or occurrence of a particular activity, and “raising” an event refers to generating and emitting the set of data representing the event. The set of data may comprise data values that are configured in any suitable format including, but not limited to, a message, a request or any similar communication, a data object, a data record, and any other formatted data entity. The activity causing an event may be performed in a computer system by executing one or more computer-implemented operations, where the one or more operations may be initiated by a user, by the computer system or components thereof, and/or by another computer system. Some examples of event-causing activities include, but are not limited to, receiving input from a user at the computer system through a GUI, receiving output from an operation performed by the computer system, and receiving a message or other communication from another computer system. It is noted that the techniques described herein are not limited to any particular type of event or to any particular type of activity that may cause an event to be raised, and for this reason the examples provided herein of events and event activities are to be considered in an illustrative rather than a restrictive sense.

Referring to step 206 in FIG. 2, the design tool may receive the third design information in the form of one or more event definitions that represent one or more events. For example, a user using the design tool to develop a mashup may drag-and-drop an event definition into the mashup. The event definition may be in the form of a visual representation (e.g., an icon) that is provided in a GUI toolbox, which may include visual representations of event definitions for events of multiple types.

Depending on the particular mashup being designed, the one or more events specified in the third design information may associate human workflows and automated processes in various manners. For example, a particular event specified in the third design information may be raised while the mashup is being executed in response to user input that is received through a particular design element in a human workflow. Thereafter, one or more automated processes may be invoked in response to the event. In another example, a particular event specified in the third design information may be raised while the mashup is being executed in response to output that is generated from a particular automated process. Thereafter, one or more operations of a human workflow may be invoked in response to the event.

In step 208, a definition of the mashup is generated based on the first design information, the second design information, and the third design information. The definition of the mashup logically integrates the plurality of design elements with the one or more automated processes based on the one or more events. The definition of the mashup, however, does not bind the design elements, the automated processes, and the events to any pre-determined execution components that are operable to execute the mashup. In this manner, by providing for generating logical mashup definitions during the design phase of mashups, the techniques described herein allow the mashups to be fully portable and to be deployable to various execution environments including, but not limited to, on-premise execution environments and SaaS execution environments.

In one embodiment, the techniques described herein for designing mashups may be implemented in a visual design tool that is intended to be used by a business analyst or developer. The visual design tool may be implemented as an integrated development environment for specifying the services, the human interaction, and other program logic that will constitute a mashup. To simplify the design process, the visual design tool operates at a logical level which abstracts away the physical and deployment details that specify how the mashup is to be deployed and executed. Because of that abstraction, the design of the mashup is simplified and is independent of the details of the eventual runtime environment in which the mashup will execute. As a result, without having extensive software or technical knowledge, the business analyst or developer would be able to easily design and develop mashups that integrate human workflows with automated processes and implement arbitrarily complex program logic.

In this embodiment, the visual design tool may provide various forms and GUI elements (e.g., visual toolboxes, drop-down boxes, icon palettes, etc.) that allow the business analyst or developer to specify one or more of at least the following design information for a mashup:

(1) Roles—the roles of end users of the mashup, where the end users will use the mashup when the mashup is being executed.

(2) Services—one or more external services that are to be integrated into the mashup. As used herein, “external service” refers to a remote service that is provided separate from and independent of a mashup that accesses the service. In some operating environments, an external service may be a service that is provided by a third-party and is configured behind a firewall and/or in a different domain than the runtime execution environment that execute a mashup. In some operating environments, an external service may be provided on an enterprise intranet. The techniques described herein are not limited to mashups that access any particular types of external services.

(3) Human Interaction Flow—this is a depiction of the states of the human workflow which shows the options available at each human interaction point and the transition or routing of the state of the human interaction from one point to another. Human workflow operations that may be performed during the transitions between states of the human workflow include, but are not limited to, the invocation of various external services, the raising of events, changes to data values, changes to states, and any other similar actions. In some embodiments, the human interaction flow may be implemented as a finite state machine, in which nodes represent the states of the human workflow and directed edges represent state transitions that may cause events to be raised.

(4) Forms—the forms which may include a layout and a set of data which are presented to the end users of the mashup for the display and entry of information.

(5) Data—the composite data structures and data elements that appear on the forms and that are used to control the state and flow of the human workflow in the mashup and of the process orchestrations of the one or more automated processes included in the mashup. Such data structures may describe the information content of a form, the input data required by a service, or the data conveyed in an event. In various implementations, these data structures may include, without limitation, tables, arrays, name-value pairs, linked lists, queues, stacks, and any other suitable data configurations.

(6) Process Orchestration Flow—this is a depiction of the automated sequences and/or control flows among services and control elements which represent the one or more automated processes included in the mashup. The automated sequences and/or control flows are also referred to herein as “process orchestrations.” Unlike Human Interaction Flows which are centered around states and transitions, process orchestrations are centered around the control and sequencing of operations in automated processes. A process orchestration flow resembles a flowchart with the typical iteration and selection control flow constructs, but also allows the specification of the splitting and joining (synchronization) of concurrent flows. In addition to the control flow constructs, the operations in a process orchestration may include the invocation of services, the raising of events, and any other similar actions.

(7) Events—events may be used to represent changes of state within the human workflows included in the mashup and various outputs generated by automated processes included in the mashup. For example, an event may indicate a change in state of a service (such as the start or completion of a service) or a change in state of an entity managed by a service (such as a financial service changing the state of an invoice to “PAID” status). Use of events to integrate the human workflows and the automated processes included in a mashup allows a greater degree of parallelism and concurrency to occur within the mashup, decreases the need for repeatedly polling a service to determine whether a change of state has occurred, and ultimately allows the business analyst or developer of the mashup to implement an arbitrary complex program logic in the mashup.

(8) Event-to-Action Maps—an event-to-action map specifies the rules for determining, at runtime when the mashup is being executed, how the raised events are filtered and routed. The filtering and routing of an event may be based on data stored in the event including, but not limited to, the type of the event, the identifier of the event, the identity of the service or the mashup element originating the event, and the type of entity the event describes. For example, one set of rules may specify that events raised by certain services are to be discarded. The same or another set of rules may specify that events emitted by certain services (e.g. an accounting service) related to certain types of entities (e.g. an invoice) that have changed state (e.g. is now in “PAID” status) are to be routed to a specific process orchestration.

In one embodiment, the logical mashup definition generated by a visual design tool according to the techniques described herein may be a package of logical design specifications that are stored in the form of a set of XML files. The visual design tool may also provide mechanisms for versioning the design elements provided in the mashup by the mashup developer, as well as mechanism for versioning the package of logical design specifications that are stored in the set of XML files. In this embodiment, the visual design tool may also comprise mechanisms for transferring the mashup design package to a deployment tool operable to deploy the mashup to an execution environment that can execute the mashup. For example, the visual design tool may allow the mashup developer to store the mashup design package in a file system or in some other suitable type of data repository that is accessible by the deployment tool.

III. Deploying Mashups that Integrate Human Workflows and Automated Processes

The example operational context illustrated in FIG. 1 depicts deployment tool 106 that is operable to deploy mashups to execution environment system 110. Deployment tool 106 may be implemented as a set of instructions which, when executed by one or more processors, are operable to generate deployment information that can be used to deploy a mashup to an execution environment system, such as system 110. In various embodiments, deployment tool 106 may be implemented as a software program code that may be executable in various ways, including but not limited to, as a standalone application, as a portion of a client-server application, and as a SaaS application.

In operation, deployment tool 106 is configured to receive a logical definition of a mashup such as, for example, logical mashup definition 104. The logical mashup definition specifies design elements that define a human workflow in the mashup and one or more automated processes in the mashup. The logical mashup definition may also specify one or more events, where a particular event associates a particular design element with a particular automated process. The logical mashup definition for a given mashup may logically integrate the design elements of the human workflow with the one or more automated processes based on the one or more events. The logical mashup definition, however, does not bind the design elements, the one or more automated processes, and the one or more events to execution components that are operable to execute the mashup.

Deployment tool 106 is also configured to receive configuration information that specifies one or more execution components (such as execution components 112 included in execution environment system 110) that are operable to execute the human workflow and the one or more automated processes included in the mashup. For example, deployment tool 106 may be operable to provide the GUI interfaces and other forms, as well as the underlying logic, through which a user may provide the configuration information that defines where and how the mashups and portions thereof are to be executed. Alternatively, or in addition to, deployment tool 106 may be configured to retrieve and determine the configuration information from a repository such as, for example, a database, a directory, or a set of configuration files stored in a file system.

Based on the logical mashup definition and on the configuration information for a given mashup, deployment tool 106 generates at least mashup deployment information 108. Mashup deployment information 108 binds each of the human workflow and the one or more automated processes to one or more execution components for execution such as, for example, execution components 112 in execution environment system 110. For example, mashup deployment information 108 may be generated by deployment tool 106 in response to receiving a logical mashup definition of a mashup from a design tool (e.g., design tool 102) and a corresponding configuration information from a user (e.g., a system administrator). Alternatively, or in addition to, mashup deployment information 108 may be automatically generated by deployment tool 106 in response to user input that specifically requests the mashup deployment information to be generated.

After mashup deployment information 108 for a given mashup is generated, deployment tool 106 may be used to deploy, or cause the deployment of, the given mashup to an execution environment system, such as system 110, based on deployment information 108. For example, deployment tool 106 may install any elements or processes included in the given mashup to the execution environment system by determining the execution components and any access parameters therefor (e.g., login information) from mashup deployment information 108.

Mashup deployment information 108 for a given mashup binds each of the human workflows and the automated processes included in the mashup to one or more execution components for execution. In one embodiment, mashup deployment information 108 may include binding 109 that comprises one or more data structures. In the one or more data structures, binding 109 stores data that associates each human workflow element and each automated process with one or more execution components for execution. For example, binding 109 may store data indicating which forms and GUI elements of a human workflow are to be executed by which web server. In another example, binding 109 may store a mapping that associates operations included in one or more automated processes with one or more network addresses of one or more servers that are operable to execute the operations. The operations may include, but are not limited to, login operations that are specified in scripts included in or generated from a logical mashup definition, invocations or calls to specific external services along with any necessary input parameters, and various messages and requests that may used to access various external services and servers such as web services and database servers. In another example, binding 109 may store an event-to-action mapping that specifies which of multiple operations in human workflows or automated processes are to be invoked in response to which of multiple events defined in a given mashup.

In various embodiments, a mashup deployment information for a given mashup may be implemented as a set of data in various formats. For example, in some embodiments a mashup deployment information may be implemented as set of scripts conforming to various scripting languages that can be executed at an execution environment system and/or the execution components thereof. In some embodiments, a mashup deployment information may be implemented as a “make” file that can be executed by an execution environment system to install the given mashup. In some embodiments, a mashup deployment information may be implemented as a set of XML files that can be parsed and processed by an execution environment system and/or the execution components thereof. Thus, the techniques described herein for deploying mashups are not limited to any particular type or format in which mashup deployment information for any given mashup is generated and used to deploy that given mashup.

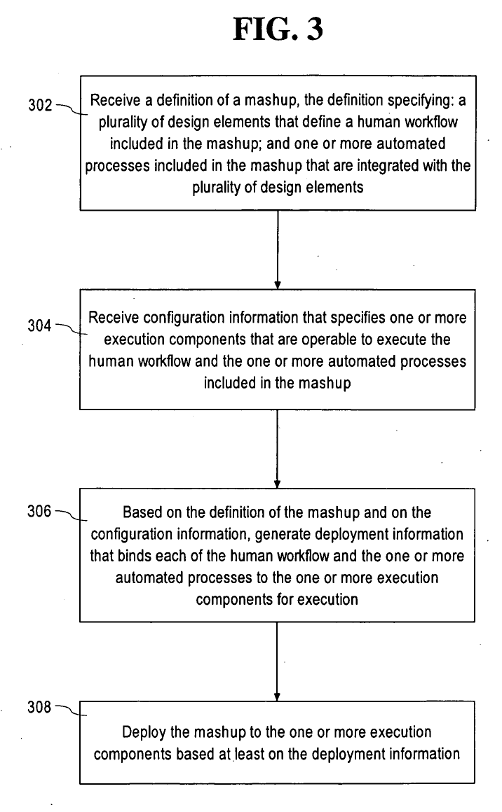

FIG. 3 is a flow diagram that illustrates a method for designing mashups according to an example embodiment.

In step 302, a deployment tool receives a logical definition of a mashup, where the definition specifies a plurality of design elements that define a human workflow included in the mashup, and one or more automated processes that are integrated in the mashup with the plurality of design elements. The logical mashup definition does not include any data that binds the design elements or the one or more automated processes to execution components that are operable to execute the mashup. In some embodiments, the logical mashup definition may further include other information including, but not limited to: role information that specifies the roles of end users that will use the mashup when the mashup is executed; event information that specifies and defines one or more events that may indicate changes experienced by the human workflow included in the mashup and/or the generation of specific output from the one or more automated processes included in the mashup; and map information that specifies one or more rules for determining, at runtime when the mashup is executed, which automated process or human workflow operation is to be invoked in response to which event defined in the mashup.

In step 304, the deployment tool receives configuration information. The configuration information specifies one or more execution components that are operable to execute the human workflow and the one or more automated processes included in the mashup. In some embodiments, the one or more execution components may comprise one or more servers or services that are identifiable by a network address (e.g., an IP address) or by a combination a network address and a port number (i.e., an IP address and a TCP port number).

In step 306, based on the logical definition of the mashup and on the configuration information, the deployment tool generates deployment information for the mashup. The deployment information binds each of the human workflow and the one or more automated processes to one or more execution components for execution. For example, the deployment information may include a mapping that associates operations in the human workflow and in the one or more automated processes with the network addresses of servers or services that are operable to execute these operations.

In some embodiments, the generated deployment information for the mashup may include an event mapping that indicates which operations, of the human workflow and the one or more automated processes in the mashup, is to be invoked in response to which event of multiple events defined in the mashup. The event mapping may be generated based on rules included in the logical definition of the mashup and on event definition information such as, for example, event types, event identifiers, and the types of entities configured to raise the events. For each listed operation, the event mapping may include information (e.g., network address, port number, etc.) that identifies one or more execution components operable to execute that operation, and the data types and number of any input parameters required by that operation.

In some embodiments, the one or more execution components may be included in a SaaS execution environment that is operable to allow multiple users to simultaneously use the mashup as a SaaS service or application while the mashup is being executed. In some embodiments, the one or more execution components may be included in an execution environment that is controlled and managed by a single entity such as, for example, in an on-premise system installed in an enterprise network.

In some embodiments, the step of generating the deployment information for the mashup may further include generating any other code or configuration information that is not included in the logical definition of the mashup but is needed for executing the mashup. For example, along with the deployment information, the deployment tool may compile into executable code any source code that is provided in the logical definition of the mashup. The generated executable code can be executed by one or more of the execution components and may include, but is not limited to: code for rendering GUIs and GUI elements that are operable to receive input from end users when the mashup is executed; code for rendering forms that are operable to receive user input or to display information to end users; scripts conforming to various scripting languages that are operable to provide a particular functionality when the mashup is executed; JavaScript code, VB script code, and any other code, which may be executed on execution components that are virtual machines; executable instructions defined in a markup language, such as XML or HTML; and instructions in extensible transformation languages, such as XSLT or CSS templates.

In step 308, the deployment tool may be used to deploy the mashup to the one or more execution components based on the deployment information. For example, the deployment tool may generate a package that includes various mashup executable such as, for example, compiled code, scripts, forms, interfaces, and files. Based on the deployment information, the deployment tool may then install, or cause the installation of, the package on the one or more execution components on which the mashup is to execute. In some embodiments, depending on the particular type of mashup being deployed and on the types of the execution components, part or all of the deployment information may be transferred to the execution components that are to execute the mashup.

According to the techniques described herein, in some embodiments the configuration information provided to a deployment tool may include the network locations of, and/or run-time configurations for, the various execution components that are operable to execute a given mashup. Once the deployment information is generated based on the logical definition of the given mashup and on the configuration information, the deployment tool would actually create, initialize, and/or start the necessary runtime entities necessary to execute the mashup. Examples of such entities include, but are not limited to, servers, services, virtual machines, software and/or hardware profiles, dynamic memory, persistent storage such as disks, and any other computer processes or data structures that are used while the given mashup is being executed. Thus, in these embodiments the end result produced by the deployment tool is an executable application that is ready to be executed on some particular execution components.

According to the techniques described herein, in some embodiments a deployment tool may be configured to generate deployment information that includes: (1) an XML definition that includes data indicating the actual locations of the physical servers that are going to execute a given mashup; and (2) any executable code that is necessary to execute the application such as, for example, code for rendering forms and other GUIs and GUI elements, Java bytecode, JavaScript and/or VB code, and any necessary scripts. In these embodiments, the XML definition and the executable code in the deployment information are such that they are understood, and can be executed, by the various execution components that are to execute the mashup.

In some embodiments, a deployment tool may store at least portions of the deployment information in a data repository, such as a directory or a database, and make that information accessible to the execution components during runtime when the mashup is executed. As a result, an execution component would be able to automatically determine and retrieve any necessary information during runtime. For example, the deployment tool may generate and store an event mapping in one or more database tables, where the event mapping indicates which operations of the human workflow and the one or more automated processes in the mashup are to be invoked in response to which events. The event mapping may also include information (e.g., network address, port number, etc.) that identifies one or more execution components operable to execute that operation, and the data types and number of any input parameters required by that operation. Thus, during runtime when a mashup is being executed, an execution component may look up in the event mapping any particular event when that event is raised by a human workflow or by an automated process included in the mashup. For example, the execution component may receive an event that is raised from a human workflow, and may determine an automated process that needs to be invoked in response to this event by performing a look-up in the event mapping based on one or more of the event type, the event identifier, the identity of the entity that raised the event, and any other data that may be carried within the event. In this manner, the techniques described herein allow execution components to dynamically determine during runtime which mashup operation needs to be invoked. In turn, this avoids the need to hard-code in the mashup during design time any calls and other requests that may be needed in the execution flow of the mashup.

In some embodiments, the deployment tool may be configured as an administration and management application that may be used by an application administrator to bind the logical mashup definitions as created by a mashup design tool to the physical environment on which the mashups will execute. In these embodiments, the deployment tool may also be configured to support a configuration management application or client that allows multiple versions of mashups and mashups elements thereof to exist concurrently and be preserved as known collections of specific versions of mashup elements.

In these embodiments, binding a logical mashup definition of a given mashup to the execution components that are going to execute mashup may include one or more of:
mapping roles to actual end users of the mashup (e.g., based on email addresses);
mapping logical external services to the physical addresses on which the services reside;
configuring runtime security and user sign-ons, and preparing any parameterized configurations for the human workflow(s) and automated process(es) included in the mashup; and
specifying whether or not the mashup is to be deployed to a shared SaaS execution environment or to a dedicated execution environment.

In these embodiments, the output of the deployment tool may be in the form of a collection of XML files, but may additionally include configuration data, Java bytecode, JavaScript code, and any other software artifacts that are required to allow the logical design of the mashup (as specified in a logical mashup definition) to be implemented and executed in a physical execution environment (such as execution components in an execution environment system).

### IV. Runtime Execution Environment

According to the techniques described herein, an execution environment system is configured to execute mashups that integrate human workflows and automated processes based on distributed events. The execution environment system comprises modules that are configured, during runtime when the mashups are executed, to facilitate interaction with end users of the mashups, to invoke automated processes included in the mashups, and to integrate the human workflows and the automated processes based on events that are raised at various points during the execution of the mashups by various operations in the human workflows and the automated processes. In some embodiments, an execution environment system in accordance with the techniques described herein is operable to interpret and execute a mashup that was designed by a design tool and that was deployed and bound for execution by a deployment tool as described heretofore.

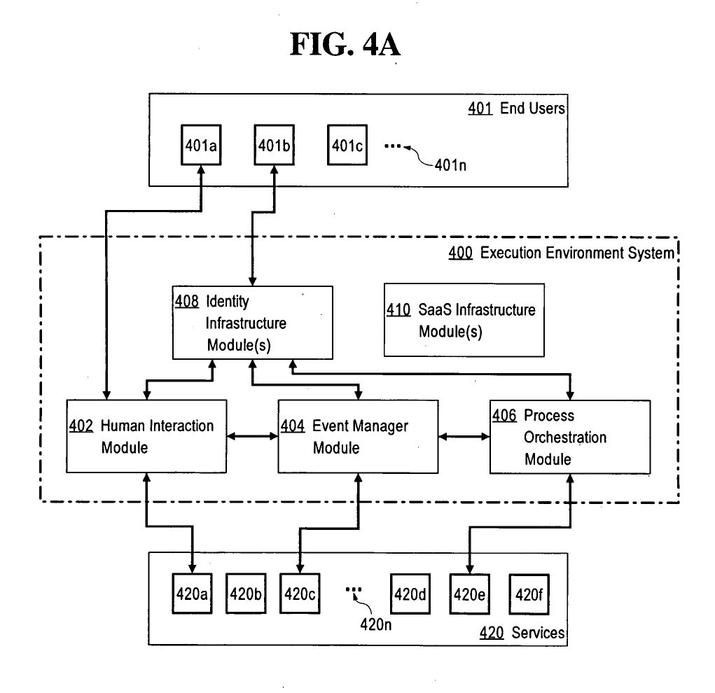

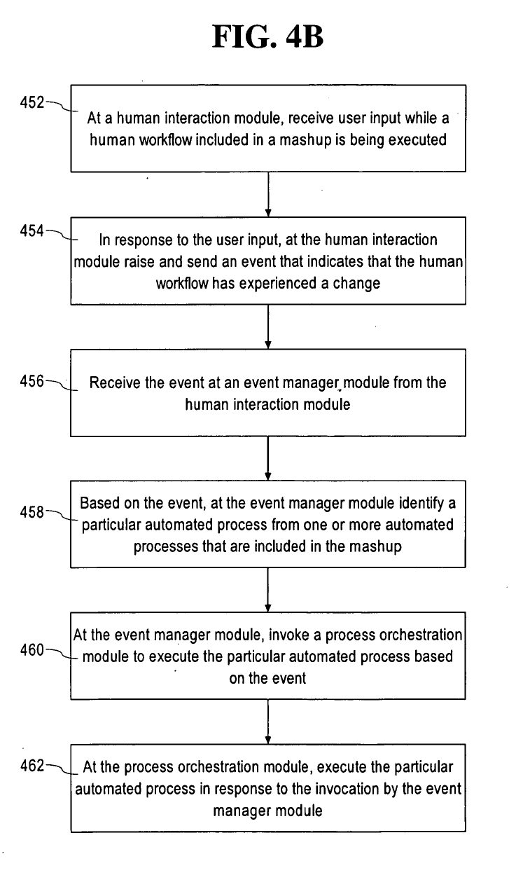

FIG. 4A is a block diagram that illustrates an example execution environment system according to one embodiment. In operation, execution environment system 400 comprises human interaction module 402, event manager module 404, and process orchestration module 406. In some embodiments, execution environment system 400 may further comprise identity infrastructure module 408 and SaaS infrastructure module 410. In various embodiments, each of modules 402, 404, 406, 408, and 410 may be implemented as a combination of software and/or hardware elements which, when executed, may be allocated computational resources, such as memory, CPU time, and/or disk storage space in order to execute a mashup or any portions thereof. For example, in operation each of modules 402, 404, 406, 408, and 410 may be an execution component that is executing as, or within, servers, services, virtual machines, daemons, and any other computer system processes that are allocated computing resources and are configured to execute mashups and/or portions thereof.

In various embodiments, the various modules of execution environment system 400 may be included on same computer system or hardware platform, on a cluster of interconnected computer systems or hardware platforms, or may be distributed on different computer systems or hardware platforms over a network. Thus, although in FIG. 4A modules 402, 404, 406, 408, and 410 are depicted in the context of an integral execution environment system, this is done for explanation purposes only. The dashed border of execution environment system 400 indicates that the different modules included in the system are not necessarily co-located at the same computer system or hardware platform. Further, in various embodiments the functionalities of human interaction module 402, event manager module 404, process orchestration module 406, identity infrastructure module 408, and SaaS infrastructure module 410 may be implemented in the same integrated module or may be combined in two or more modules that may provide some additional functionalities. For these reasons, the depiction of execution environment system 400 in FIG. 4A is to be regarded in an illustrative rather than a restrictive sense.

As an operational example, suppose that a given mashup (not shown in FIG. 4A) is being executed at execution environment system 400. In execution, the mashup is being used by one or more end users 401 such as, for example, end users 401a, 401b, and 401c. Ellipsis 401n indicates that the mashup may be used by any number of human end users.

In execution, the mashup is operable to access one or more external services 420 such as, for example, external services 420a, 420b, 420c, 420d, 420e, and 420f. Ellipsis 420n indicates that the mashup may be operable to access any number of external services. External services 420 are invoked at runtime by execution environment system 400 on behalf of the mashup being executed, but are not themselves a part of execution environment system 400. According to the techniques described herein, external services may be a part of or accessed by a mashup that is being executed, and may be coordinated by the components of the execution environment system that is executing the mashup. The external services accessed by a given mashup, such as external services 420, may be chosen by the mashup designers and may be mapped into physical execution components by administrators using a deployment tool as described heretofore. Various external services may be invoked by sending messages to them. Various external services may also emit messages or events as a result of an invocation.

### Human Interaction Module

Within execution environment system 400, human interaction module 402 is communicatively and/or operatively coupled to event manager module 404, to identity infrastructure module 408, and (when present in the system) to SaaS Infrastructure module 410. For example, human interaction module 402 may use any suitable inter-process communication mechanism to exchange requests and data with event manager module 404 and identity infrastructure module 408. Examples of such inter-process communication mechanisms include, but are not limited to, various message-based protocols, shared memory, application programming interfaces (APIs), and call-back interfaces. Human interaction module 402 is also configured to receive input from end users, such as for example end users 401, and to access one or more of external services, such as for example external services 420.

In operation when a mashup is being executed, human interaction module 402 is configured to coordinate the state-based interactions with end users 401 by interpreting the states of the human interaction flow of the human workflow included in the mashup. For example, human interaction module 402 may be configured to detect transitions from one state of the human workflow to another. The transitions may involve moving a particular mashup item from one user's queue to another user's queue, depending on user input. Thus, human interaction module 402 governs the creation of various items during runtime and the movement of the items from one end user to another based on the rules and program logic that are defined in the mashup.

In some embodiments, human interaction module 402 may use a finite state machine to implement the states of the human workflow that is included in a given mashup. Human interaction module 402 is configured to render any GUIs, GUI elements, and other forms that are included in the mashup for receiving input from end users 401 and for displaying information to end users 401. For example, human interaction module 402 may use a web server to render such GUIs, GUI elements, and other forms to web browsers used by end users 401.

While a mashup is being executed at execution environment system 400, human interaction module 402 is configured to receive user input from a human workflow included in the mashup. In response to the user input, human interaction module 402 is configured to raise an event which indicates that the human workflow has experienced a change. While the mashup is being executed, human interaction module 402 is also configured to execute a particular operation in the human workflow in response to an invocation from event manager module 404, where event manager module 404 may send the invocation in response to an event that is raised by an external service and/or by an automated process.

### Event Manager Module

Within execution environment system 400, event manager module 404 is communicatively and/or operatively coupled to human interaction module 402, to process orchestration module 406, to identity infrastructure module 408, and (when present in the system) to SaaS Infrastructure module 410. For example, event manager module 404 may use any suitable inter-process communication mechanism to exchange requests and data with human interaction module 402, process orchestration module 406, and identity infrastructure module 408. Examples of such inter-process communication mechanisms include, but are not limited to, various message-based protocols, shared memory, application programming interfaces (APIs), and call-back interfaces. Event manager module 404 may also be configured to access, and receive information and events from, one or more of external services such as external services 420.

At the time when a given mashup is deployed to execution environment system 400, an event mapping for that mashup may be stored in one or more data structures that are controlled and/or accessible by event manager module 404. The event mapping includes data that indicates which operations, of the human workflow and the one or more automated processes in the mashup, are to be invoked in response to which event defined in the mashup. For each event that is defined in the mashup, the event mapping may include data that identifies the operation that is to be invoked in response to the event, as well as any other data associated with the operation and/or with the event including, but not limited to, the data type and the number of input parameters for the operation, the event ID, the type of the event, and the type and/or identity of the entity that is allowed to raised the event during runtime. The data structures in which the event mapping is stored may be any suitable data structures including, but not limited to, one or more database tables, arrays and other similar data structures that are initialized in dynamic memory or on persistent storage, data records of various formats that are stored in files or directories on persistent storage, and any other suitable combination of data structures that may be stored in dynamic memory and/or on persistent storage.

In operation when a mashup is being executed, event manager module 404 is configured to receive, resolve, and route events that are raised by the various other modules in execution system environment 400 (e.g., modules 402, 406, 408, and/or 410), as well as events that are raised by external services (e.g., external services 420). For example, event manager module 404 may be operable at least to: receive an event from human interaction module 402; based on the data included in the event, look-up the event in the data structures that store the event mapping; based on the event mapping data for the event, identify a particular automated process in the mashup that needs to be invoked in response to the event; and invoke process orchestration module 406 to execute the identified automated process. Event manager module 404 may also be operable to process events raised by automated processes and external services in a similar manner. For example, event manager module 404 may be operable to: receive an event from process orchestration module 406; based on the data included in the event, look-up the event in the data structures that store the event mapping; based on the event mapping data for the event, identify a particular operation that is included in the human workflow of the mashup and that needs to be invoked in response to the event; and invoke human interaction module 402 to execute the identified operation. In another example, event manager module 404 may be operable to: receive an event from an external service; based on the data included in the event, look-up the event in the data structures that store the event mapping; based on the event mapping data for the event, identify a particular automated process and/or a human workflow operation that needs to be invoked in response to the event; and invoke process orchestration module 406 and/or human interaction module 402 to execute the identified automated process and/or human workflow operation.

In this manner, according to the techniques described herein event manager module 404 is operable to detect and resolve events that are raised by the various other modules in execution system environment 400 at runtime during the execution of mashups. Since event manager module 404 receives, resolves, and routes events for a given mashup on the fly at runtime, the event manager module is capable of integrating human workflows, automated processes, and external services in a flexible and efficient way that places very few, if any, design restrictions on the mashup. In turn, this allows users with fairly low technological knowledge (e.g., business analysts as compared to software developers) to design and develop mashups that include arbitrary complex program logic and that transparently integrate human workflows, automated processes, and external services.

In some embodiments, according to the techniques described herein an event manager module may be configured to integrate a human workflow included in a mashup with one or more automated processes based on asynchronous events and/or on synchronization points.

For example, in these embodiments the event manager module may receive an asynchronous event from a human interaction module, where the asynchronous event is raised in response to user input received in the human workflow of a given mashup that is being executed. The event manager module may look-up the asynchronous event in the data structures that store the event mapping for that mashup. Based on the event mapping data for the asynchronous event, the event manager module may determine that a particular automated process needs to be executed in parallel with the execution of the human workflow in the mashup. The event manager module may then cause (e.g., by making the appropriate call to) a process orchestration module to execute the determined automated process in parallel with the execution of the human workflow.

In another example, in response to a received event, the event manager module may look-up the received event in the data structures that store the event mapping for the mashup being executed. Based on the event mapping data for that event, the event manager module may determine a particular point in the mashup at which the execution of a human workflow in the mashup is to be synchronized with execution of one or more automated processes. Thereafter, when the event manager detects that the execution of the mashup has reached the particular point (e.g., by receiving a particular event that is associated with the particular execution point in the mashup), the event manager may cause (e.g., by making the appropriate calls to) a process orchestration module and/or a human interaction module to synchronize the execution of the human workflow in the mashup with the execution of the one or more automated processes.

### Process Orchestration Module

Within execution environment system 400, process orchestration module 406 is communicatively and/or operatively coupled to event manager module 404, to identity infrastructure module 408, and (when present in the system) to SaaS Infrastructure module 410. For example, process orchestration module 406 may use any suitable inter-process communication mechanism to exchange requests and data with event manager module 404 and identity infrastructure module 408. Examples of such inter-process communication mechanisms include, but are not limited to, various message-based protocols, shared memory, application programming interfaces (APIs), and call-back interfaces. Process orchestration module 406 is also configured to access external services such as, for example, external services 420.

According to the techniques described herein, process orchestration module 406 is operable to create instances of process orchestrations at runtime while a mashup is being executed. Process orchestration module 406 is also operable to execute the instantiated process orchestrations, to receive or otherwise detect output from operations in the process orchestrations, and to raise events in response to the detected output.

In operation when a mashup is being executed, process orchestration module 406 is configured to execute automated processes in response to being invoked by event manager module 406. For example, while a given mashup is being executed at execution environment system 400, event manager module 404 may receive an event from a human workflow included in that mashup and/or from one or more external services accessed by that mashup. Event manager module 404 resolves the event and identifies a particular automated process that needs to be invoked in response to the event. Event manager module 404 then causes process orchestration module 406 to execute the automated process. In response to being invoked by event manager module 404, process orchestration module 406 executes the identified automated process. For example, event manager module 404 may invoke process orchestration module 406 by making a call with appropriate parameters or by sending a message that includes the appropriate data. Process orchestration module 406 is also configured to raise an event in response to output from one or more automated processes that are executed by the process orchestration module during the execution of a given mashup.

In some embodiments, a process orchestration module in an execution environment system is operable to execute automated processes that do not depend on and do not require human user interactions. In these embodiments, the process orchestration module may automate a sequence of steps, actions, or activities in a particular process orchestration that represents a particular automated process. An example of such automated process would be the generation of an executable file from a set of source code files, where the generation of the executable file includes a sequence of two operations: first compiling the set of source code files into object files, and then linking the object files into the executable file. According to the techniques described herein, the process orchestration module is operable to perform the generation of the executable files as a background process that performs the compiling and linking operations without any human interaction.

In these embodiments, the automated processes orchestrated by the process orchestration module can be triggered by events that are received from an event manager module. The process orchestration module is also operable to detect events triggered by the automated processes. For instance, in the above example for generating the executable file, the process orchestration module may be operable to detect any errors raised during the compiling or linking operations. In response to detecting such an error, the process orchestration module is operable to raise an event, where the event includes information describing the error, and to emit the event to the event manager module. In these embodiments, the process orchestration module may also be operable to receive events that are raised by external services that are accessed by the process orchestration module during the execution of the automated processes. For instance, the process orchestration module may be configured to detect a login failure event that is raised by a web service in response to the process orchestration module attempting to login to the web service by using incorrect or invalid login credentials.

### Identity Infrastructure Module

The techniques described herein provide for designing and deploying mashups that integrate human workflows with automated process and/or that access one or more external services. The techniques described herein also provide for executing mashups for the benefit of end users. Since mashup designers as well as end users are involved in a mashup's life-cycle, in some operational context there would be a need to identify mashup designers and mashup end users, to authenticate mashup designers and mashup end users, and to convey and map those user identities across events, human workflows, automated processes, and external service invocations. According to the techniques described herein, in these operational contexts an execution environment system may provide an identity infrastructure module that is operable to perform user identification, authentication, and authorization functions, to deliver the appropriate user identities to human workflows, automated processes and external services, and to validate that these user identities have not been tampered with or altered during the mashup design, development, and/or execution.

As illustrated in FIG. 4A, within execution environment system 400, identity infrastructure module 408 is communicatively and/or operatively coupled to human interaction module 402, to event manager module 404, to identity infrastructure module 408, and (when present in the system) to SaaS Infrastructure module 410. Identity infrastructure module 408 may use any suitable inter-process communication mechanism to exchange requests and data with the other modules in execution environment system 400. Examples of such inter-process communication mechanisms include, but are not limited to, various message-based protocols, shared memory, application programming interfaces (APIs), and call-back interfaces. Identity infrastructure module 408 is also configured to receive input from mashup end users such as end users 401, and/or from users that design and deploy mashups (not shown in FIG. 4A).

Identity infrastructure module 408 is operable to identify and authenticate users. In some embodiments, identity infrastructure module 408 may include program logic that performs user identification and authentication. In other embodiments, identity infrastructure module 408 may be communicatively connected to servers or services that can provide user authentication; examples of such servers or services include, but are not limited to, authentication authorization accounting (AAA) servers, network domain controllers, Active Directory servers, Lightweight Directory Access Protocol (LDAP) servers, and the like. Thus, according to the techniques described herein an identity infrastructure module is not limited to any particular mechanism for authenticating mashup end users and/or mashup designers.

In operation, while a mashup is being executed at execution environment system 400, identity infrastructure module 408 is configured at least to: receive identification credentials (e.g., a username and a password) from end users that use the mashup such as end users 401; authenticate the end users based on the identification credentials; generate identity tokens for those users that are authenticated; verify or validate identity tokens that are received from the other modules in execution environment system 400 in order to determine whether end users associated with the received identity tokens are permitted to perform specific operations in the mashup; and, based on the identity tokens, determine and provide the identification credentials of the end users to external services that are accessed by the mashup while the mashup is being executed at the system. In various embodiments, identity infrastructure module 408 may generate identity tokens of various formats and structures. Examples of such identity tokens include, but are not limited to, user IDs, globally unique identifiers (GUIDs), digital signatures, and any other formatted data that can be used to uniquely identify users.

In some embodiments, each module in execution environment system 400 that is capable of raising events may also be configured to include, in some or all raised events, the identity tokens of the end users that cause these events to be raised. For example, human interaction module 402 may receive input from an end user. Human interaction module 402 may determine the identity token associated with that end user, and may then raise an event in response to the input, where the event includes the identity token. Similarly, process orchestration module 406 may detect or receive output from an automated process. Process orchestration module 406 may then determine the identity token associated with an end user that caused the automated process to be executed, and may raise an event that includes the identity token. In this manner, by including within events identity tokens that identify end users, the techniques described herein provide for propagating user identities throughout the execution flow of a mashup. Further, by providing an identity infrastructure module that is operable to identify users across events, human workflows, automated processes, and external services, the techniques described herein allow for tracking the identities of end users of mashups that may span different networks and domains and that may access different external services each of which may have its own authentication and user-identification mechanisms.

In some embodiments, each of human interaction module 402, event manager module 404, process orchestration module 408, and SaaS infrastructure module 410 may be operable to send identity tokens of end users to identity infrastructure module 408, and may request from the identity infrastructure module to determine whether the users associated with these identity tokens are allowed to provide input to, or otherwise access, the particular requesting module. For example, prior to receiving input in a human workflow of a mashup, human interaction module 402 may send to identity infrastructure module 408 the identity token associated with the end user that is attempting to provide the input. Based on the identity token, identity infrastructure module 408 may determine the identity of the end user and may determine whether the end user is allowed to provide input to human interaction module 402. In another example, event manager module 404 may send to identity infrastructure module 408 the identity token that is included in an event that is received by the event manager module. Based on the identity token, identity infrastructure module 408 may determine the identity of the end user and may determine whether the end user is allowed cause the event to be raised and propagated by event manager module 404. In another example, process orchestration module 408 may send to identity infrastructure module 408 the identity token that is associated with an end user that invokes an automated process. Based on the identity token, identity infrastructure module 408 may determine the identity of the end user and may determine whether the end user is allowed to invoke the automated process. In this example, in addition to requesting verification and validation of the identity token, process orchestration module 406 may request and identity infrastructure module 408 may provide some identification credentials or other login information that is required for invoking the automated process.

In some embodiments, the techniques described herein provide for an identity infrastructure module that is configured to provide a single sign-on for all end users of a mashup. When an end user initiates or is contacted initially by a mashup while the mashup is being executed, the identity infrastructure module provides an identity token for that user. The identity token of the end user us then propagated in the appropriate events when the user causes an operation of the mashup to be executed. In this manner, in these embodiments the identity infrastructure module provides user tracking across events, human workflows, and automated processes that are defined in mashups.

### SaaS Infrastructure Module

The techniques described herein provide the ability to deploy mashups into a SaaS execution environment. For example, a SaaS execution system may be hosted on a global network, such as the Internet, and may be shared among many mashup owners. Such SaaS execution system provides economies of execution by sharing common hardware and infrastructure while keeping logically isolated the design, deployment, and execution artifacts of mashups designed and owned by different customers that share the SaaS execution system.

By providing for deployment of mashups in a SaaS execution environment, the techniques described herein allow mashup designers and mashup end users great flexibility in designing and using various types of mashups. For example, a mashup designed for use by an organization may be deployed in a SaaS execution system in order to outsource the hardware and software infrastructure and maintenance, while restricting access to employees within the organization. In another example, a mashup designed for use by external parties (e.g. partners, customers, and perhaps heretofore unknown parties) may be deployed in a SaaS execution system in order to outsource the hardware and software infrastructure and maintenance to a hosting service provider.

Within execution environment system 400, SaaS infrastructure module 410 may be communicatively and/or operatively coupled to human interaction module 402, to event manager module 404, to process orchestration module 406, and to identity infrastructure module 408. SaaS infrastructure module 410 may use any suitable inter-process communication mechanism to exchange requests and data with the other modules in execution environment system 400. Examples of such inter-process communication mechanisms include, but are not limited to, various message-based protocols, shared memory, application programming interfaces (APIs), and call-back interfaces. SaaS infrastructure module 410 may also be configured to receive input from mashup end users such as end users 401, and/or to access external services such as external services 410.

In some embodiments, SaaS infrastructure module 410 may be operable to allow human interaction module 402, event manager module 404, process orchestration module 406, and identity infrastructure module 408 to be provided as SaaS services over a network. When an end user of a mashup attempts to access a mashup that is being executed, SaaS infrastructure module 410 may be operable to send an identity token associated with the end user to identity infrastructure module 408, and may request the identity infrastructure module to determine whether the end user is allowed to access the mashup.

In these embodiments, SaaS infrastructure module 410 may use a multi-tenancy execution model, according to which multiple customers may host their mashups on the same set of computer systems or hardware platforms. From the customers' perspective, the customers can simply build their own mashups and deploy them into execution environment system 400. SaaS infrastructure module 410 includes program code that allows the communications and data for the mashups of each customer to be handled in a secure and private way. For example, SaaS infrastructure module 410 may include logic that partitions and hosts separately from each other the data, events, human workflows, and automated processes of each customer. SaaS infrastructure module 410 may implement such partitioning at the hardware level (e.g., by providing separate disk storage space for each customer), at the software level (e.g., by providing separate instances of servers and services for executing the mashups of each customer), and/or at the event management level (by identifying and handling separately the events raised by the mashups for each customer). By using a per-customer partitioning of data, events, human workflows, and automated processes, SaaS infrastructure module 410 avoids cross-customer clashes and allows the other modules of execution environment system 400 to be implemented as SaaS services.

### Executing Mashups that Integrate Human Workflows and Automated Processes

FIG. 4B is a flow diagram that illustrates an example method for executing mashups according to one embodiment.

In step 452, user input is received while a human workflow included in a mashup is being executed at an execution environment system. The mashup may be operable to integrate the human workflow with one or more automated processes and with data that is provided by one or more external services. The user input may be received at a human interaction module of the execution environment system, where the human interaction module is configured to coordinate the state-based interactions of the human workflow with input received from end users of the mashup and to render any GUIs, GUI elements, and other forms for receiving the input from the end users and for displaying information to the end users.

In step 454, an event is raised in response to receiving the user input, where the event indicates that the human workflow of the mashup has experienced a change. For example, the human interaction module may generate a message that includes data that represents the event, where the message data may include, without limitation, an event type, an event ID, and an identity token associated with the mashup end user that provided the input. The human interaction module may then send the message to an event manager module of the execution environment system, where the event manager module is configured to receive, resolve, and process events that are raised while the mashup is being executed.

In step 456, the event manager module receives the event raised by the human interaction module. For example, the event manager module may receive a message from the human interaction module, where the message includes data representing the event. If the message includes an identity token that is associated with raised event, the event manager module may send the token for validation and verification to an identity infrastructure module of the execution environment system.

In step 458, the event manager module identifies a particular automated process that needs to be invoked in response to the event. For example, based on the data included in the event, the event manager module may look-up the event in data structures that store an event mapping for the mashup that is being executed. Based on the event mapping data for the event, the event manager module may then identify the particular automated process that needs to be invoked in response to the event.

In step 460, the event manager module invokes a process orchestration module of the execution environment system to execute the identified automated process. For example, in order to invoke the process orchestration module, the event manager module may generate a message that includes data that identifies the automated process and specifies one or more input parameters for the automated process. The data in the message may also include an identity token associated with the end user that caused the event to be raised. The data in the message may be generated based on the event received from the human interaction module, on the event mapping data associated with the event, and/or on other event information that may retrieved by the event manager module during runtime when the mashup is being executed.

In step 462, the automated process identified by the event manager module is executed at the process orchestration module. For example, the process orchestration module may receive a message from the event manager module and, based on the data in the message, may determine which automated process to execute. If the data in the message includes an identity token associated with an end user, the process orchestration module may send the token for validation and verification to the identity infrastructure module. In addition, the process orchestration module may request from the identity infrastructure module additional information (e.g., login information) that may be needed to invoke the automated process.

### V. Runtime Operational Example

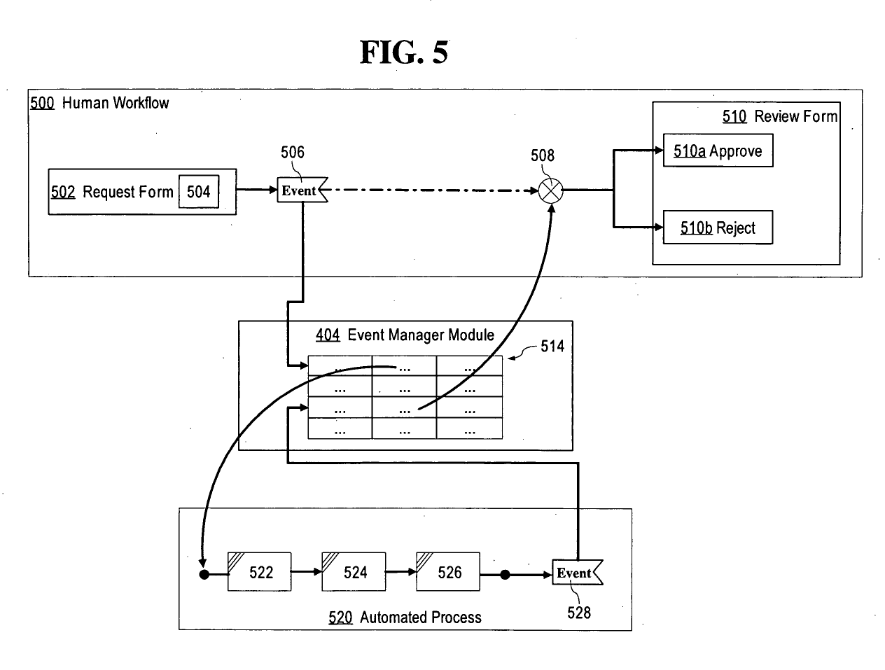

FIG. 5 is a block diagram that illustrates a runtime operational example according to one embodiment.

Suppose that a mashup is deployed in an execution environment system that includes event manager module 404. The mashup is designed to allow sales persons to request approval of discounts from their managers for sales to customers. In order to assist the managers, the mashup also includes multiple automated processes such as automatically checking the credit ratings of the customers, automatically checking the outstanding balances of the customers with respect to pervious sales, and automatically checking the volumes of the previous sales to the customers.

The mashup includes human workflow 500 that is designed to handle the interactions with the sales persons and with their managers. When the mashup is deployed to the execution environment system, an event mapping for that mashup is stored in tables 514 that are controlled and/or accessible by event manager module 404. The event mapping includes data that indicates which operations, of human workflow 500 and of the multiple automated processes included in the mashup, are to be invoked in response to each event that may be raised at runtime during execution of the mashup.

At mashup runtime, a sales person signs on to the execution environment system using a web browser. In response to the sales person's sign on, the execution environment system or a component thereof authenticates the sales person's sign-on credentials, and generates an identity token that is associated with the sales person. After the sales person is successfully authenticated, control returns to human workflow 500 and the sales person invokes discount request form 502. Thereafter, the execution environment system renders or causes request form 502 to be rendered in the sales person's browser. When request form 502 is displayed in the sales person's browser, the sales person enters data 504. Data 504 indicates various parameters for a current sale handled by the sales person. Such parameters may include, without limitation, the type and quantity of goods included in the sale, the total sale price, the customer identifier, and the requested discount. When the sales person is finished with entering data 504, the sales person hits a “SUBMIT” button on request form 502, and the form along with data 504 is sent to the execution environment system.

In response to the sales person's submission of form 502, a human interaction module of the execution environment system raises event 506. Within event 506, the human interaction module includes the identity token that represents the sales person, the type and identifier of the event, and some or all of data 504 such as, for example, the customer identifier. The human interaction module then sends event 506 to event manager module 404.

Event manager module 404 receives event 506 and, based on the data included in the event, looks up the event in tables 514. Based on the event mapping data for event 506 that is stored in tables 514, event manager module 404 determines that automated process 520 is to be invoked in response to event 506. Automated process 520 is designed to automatically check in a corporate accounting system whether a particular customer has any outstanding balance for any previous sales.

After determining that automated process 520 is to be invoked in response to event 506, event manager module 404 causes a process orchestration module to invoke the automated process. To accomplish this, event manager module 404 makes a call to the process orchestration module, where the call includes the parameters that are required for executing automated process 520. Examples of such parameters include, without limitation, the identity token of the sales person and the customer identifier.

In response to the call from event manager module 404, the process orchestration module executes automated process 520. In operation 522, the process orchestration module uses the identity token to retrieve from an identity infrastructure module login information for the corporate accounting system. Thereafter, in operation 524 the process orchestration module logs into the corporate accounting system using the login information. After logging in, in operation 526 the process orchestration module uses the customer identifier received from event manager module 404 to generate and submit a query to the corporate accounting system. In response to operation 526, the process orchestration module receives from the corporate accounting system an output data which indicates the outstanding balance for the customer.

In response to receiving the output from operation 526, the process orchestration module raises event 528. Within the event, the process orchestration module includes the identity token that represents the sales person and the type and identifier of event 528. The process orchestration module then sends event 528 to event manager module 404. Event 528 may include the customer identifier as well as the output data from operation 526 that indicates the customer's outstanding balance.

Event manager module 404 receives event 528 and, based on the data included in the event, looks up the event in tables 514. Based on the event mapping data for event 528 that is stored in tables 514, event manager module 404 determines that operation 508 in human workflow 500 is to be invoked in response to event 528. Operation 508 is designed to send a review form to the manager of the sales person.

After determining that operation 508 is to be invoked in response to event 528, event manager module 404 causes the human interaction module to execute operation 508. To accomplish this, event manager module 404 makes a call to the human interaction module, where the call includes the parameters that are required for executing operation 508. Examples of such parameters include, without limitation, the customer identifier and the outstanding balance for the customer that is received in event 528.

The human interaction module then executes operation 508. If the manager of the sales person is not signed on to the execution environment system, executing operation 508 may include sending an e-mail to the manager requesting that she signs on. Operation 508 then retrieves data 504 from request form 502 and the customer's outstanding balance that is received from event manager module 404. Thereafter, when the manager has signed on, the execution environment system renders or causes review form 510 to be rendered in the manager's web browser.

Review form 510 displays the data about the current sale (as retrieved from request form 502) and the customer's outstanding balance. The data about the current sale may include, without limitation, the identity of the sales person requesting the discount, the type and quantity of goods included in the sale, and the amount of the requested discount. Based on the displayed data about the sale and the customer's outstanding balance, the manager may then provide input 510a to approve the requested discount or input 510b to reject the discount. After the manager submits the form to the execution environment system, the human interaction module may convey the manager's decision to the sales person (e.g., by rendering the decision in the sales person's browser) and/or may record the manager's decision in a sales order system.

It is noted that various mashups may include different interoperability activities between human workflows and automated processes. For example, human workflows and automated processes included in various mashups may be designed to access one or more external services. Further, in some embodiments an event manager module may be operable to receive and process events from third-party or external services. For example, in response to an event received from an external service, the event manager module may look up the event in one or more data structures that store an event mapping. Based on the event mapping data for the event received from the external service, the event manager module may identify a human workflow operation and/or an automated process that need to be invoked in response to the event. Thus, the techniques described herein are not limited to being implemented for any particular types of mashups or for any particular types of events, and for this reason the runtime operational example depicted in FIG. 5 is to be regarded in an illustrative rather than a restrictive sense.

### VI. Implementation Mechanisms

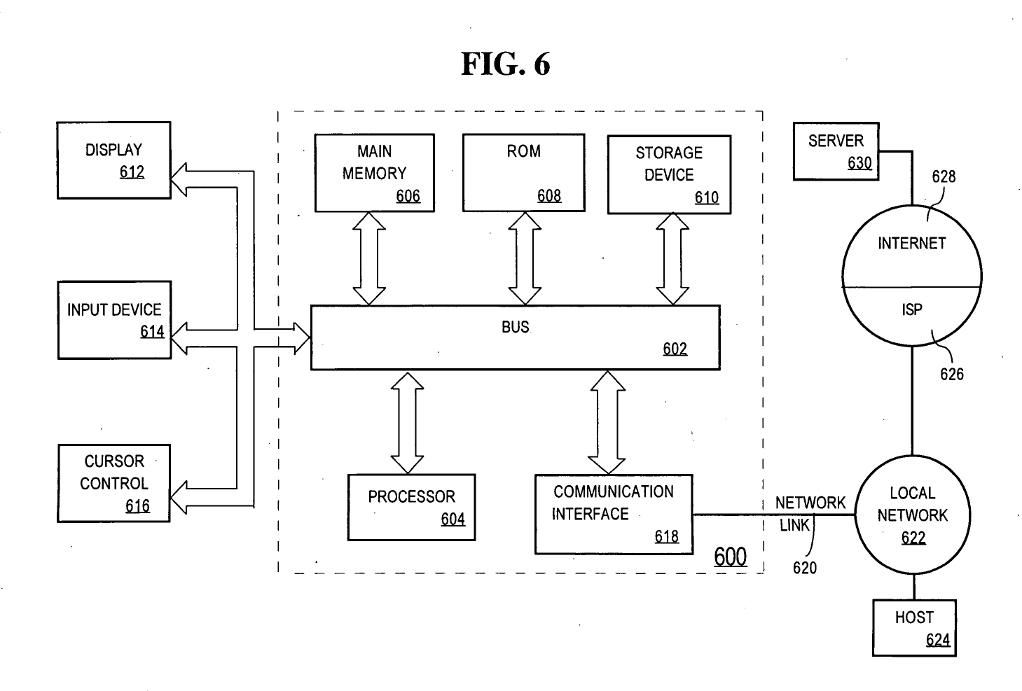

Depending upon a particular implementation, the techniques described herein may be implemented in any context and on any kind of computing platform or architecture, and are not limited to any particular context, computing platform, or architecture. For purposes of explanation, FIG. 6 is a block diagram that illustrates an example computer system 600 upon which embodiments of the techniques described herein may be implemented.

Computer system 600 includes a bus 602 or other communication mechanism for communicating information, and a processor 604 coupled with bus 602 for processing information. Computer system 400 also includes a main memory 406, such as a random access memory (RAM) or other dynamic storage device, coupled to bus 402 for storing information and instructions to be executed by processor 604. Main memory 606 also may be used for storing temporary variables or other intermediate information during execution of instructions to be executed by processor 604. Computer system 600 further includes a read only memory (ROM) 608 or other static storage device coupled to bus 602 for storing static information and instructions for processor 604. A storage device 610, such as a magnetic disk or optical disk, is provided and coupled to bus 602 for storing information and instructions.

Computer system 600 may be coupled via bus 602 to a display 612, such as a cathode ray tube (CRT), for displaying information to a computer user. An input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane.

The invention is related to the use of computer system 600 for implementing the techniques described herein for designing, deploying, and executing mashups. According to one embodiment, those techniques are performed by computer system 600 in response to processor 604 executing one or more sequences of one or more instructions contained in main memory 606. Such instructions may be read into main memory 606 from another computer-readable medium, such as storage device 610. Execution of the sequences of instructions contained in main memory 606 causes processor 604 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing data that causes a machine to operate in a specific fashion. In an embodiment implemented using computer system 600, various computer-readable media are involved, for example, in providing instructions to processor 604 for execution. Such a medium may take many forms, including but not limited to storage media and transmission media. Storage media includes both non-volatile media and volatile media. Non-volatile media includes, for example, optical or magnetic disks, such as storage device 610. Volatile media includes dynamic memory, such as main memory 606. Transmission media includes coaxial cables, copper wire and fiber optics, including the wires that comprise bus 602. Transmission media can also take the form of acoustic or light waves, such as those generated during radio-wave and infra-red data communications. All such media must be tangible to enable the instructions carried by the media to be detected by a physical mechanism that reads the instructions into a machine such as, for example, a computer system.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer-readable media may be involved in carrying one or more sequences of one or more instructions to processor 604 for execution. For example, the instructions may initially be carried on a magnetic disk of a remote computer. The remote computer can load the instructions into its dynamic memory and send the instructions over a telephone line using a modem. A modem local to computer system 600 can receive the data on the telephone line and use an infra-red transmitter to convert the data to an infra-red signal. An infra-red detector can receive the data carried in the infra-red signal and appropriate circuitry can place the data on bus 602. Bus 602 carries the data to main memory 606, from which processor 604 retrieves and executes the instructions. The instructions received by main memory 606 may optionally be stored on storage device 610 either before or after execution by processor 604.

Computer system 600 also includes a communication interface 618 coupled to bus 602. Communication interface 618 provides a two-way data communication coupling to a network link 620 that is connected to a local network 622. For example, communication interface 618 may be an integrated services digital network (ISDN) card or a modem to provide a data communication connection to a corresponding type of telephone line. As another example, communication interface 618 may be a local area network (LAN) card to provide a data communication connection to a compatible LAN. Wireless links may also be implemented. In any such implementation, communication interface 618 sends and receives electrical, electromagnetic or optical signals that carry digital data streams representing various types of information.

Network link 620 typically provides data communication through one or more networks to other data devices. For example, network link 620 may provide a connection through local network 622 to a host computer 624 or to data equipment operated by an Internet Service Provider (ISP) 626. ISP 626 in turn provides data communication services through the worldwide packet data communication network now commonly referred to as the “Internet” 628. Local network 622 and Internet 628 both use electrical, electromagnetic or optical signals that carry digital data streams. The signals through the various networks and the signals on network link 620 and through communication interface 618, which carry the digital data to and from computer system 600, are exemplary forms of carrier waves transporting the information.

Computer system 600 can send messages and receive data, including program code, through the network(s), network link 620 and communication interface 618. In the Internet example, a server 630 might transmit a requested code for an application program through Internet 628, ISP 626, local network 622 and communication interface 618. The received code may be executed by processor 604 as it is received, and/or stored in storage device 610, or other non-volatile storage for later execution. In this manner, computer system 600 may obtain application code in the form of a carrier wave.

In the foregoing specification, embodiments of the invention have been described with reference to numerous specific details that may vary from implementation to implementation. Thus, the sole and exclusive indicator of what is, and is intended by the applicants to be, the invention is the set of claims that issue from this application, in the specific form in which such claims issue, including any subsequent correction. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A system for executing mashups, the system comprising:
a human interaction module configured at least to:
receive user input while a human workflow included in a mashup is being executed at the system; and
in response to the user input, raise a first event that indicates that the human workflow has experienced a change;
an event manager module configured at least to:
receive the first event from the human interaction module;
based on the first event, identify a particular automated process from one or more automated processes that are included in the mashup; and
invoke a process orchestration module to execute the particular automated process based on the first event; and
the process orchestration module that is configured at least to:
execute the particular automated process in response to being invoked by the event manager module.

2. The system as recited in claim 1, wherein:
the process orchestration module is further configured to:
raise a second event in response to output from one or more operations included in the particular automated process;
the event manager module is further configured to:
receive the second event from the process orchestration module;
based on the second event, identify a particular operation that is included in the human workflow; and
invoke the human interaction module to execute the particular operation in the human workflow based on the second event; and
the human interaction module is further configured to:
execute the particular operation in the human workflow in response to being invoked by the event manager module.

3. The system as recited in claim 1, wherein the mashup is a composite application that is operable to:
access one or more external services; and
integrate the human workflow, the one or more automated processes, and data that is provided by the one or more external services in order to produce one or more results of the composite application.

4. The system as recited in claim 1, wherein the event manager module is further configured to integrate the human workflow with the one or more automated processes based on one or more of asynchronous events and synchronization points.

5. The system as recited in claim 1, wherein the first event is an asynchronous event and the event manager module is further configured to:
based on the asynchronous event, determine that the particular automated process is to be executed in parallel with execution of the human workflow; and
cause the process orchestration module to execute the particular automated process in parallel with the execution of the human workflow.

6. The system as recited in claim 1, wherein the event manager module is further configured to:
determine a particular point in the mashup at which execution of the human workflow is to be synchronized with execution of the one or more automated processes; and
when execution of the mashup reaches the particular point, cause the process orchestration module and the human interaction module to synchronize the execution of the human workflow with the execution of the one or more automated processes.

7. The system as recited in claim 1, wherein the event manager module configured to identify the particular automated process is further configured to:
inspect one or more data structures, wherein the one or more data structures associate events with automated processes, and wherein the one or more data structures were generated when the mashup was deployed to the system; and
determine that the first event is associated with the particular automated process in the one or more data structures.

8. The system as recited in claim 1, wherein:
the human interaction module is further configured to send a first message to the event manager module, wherein the first message includes first data that represents the first event;
the event manager module is further configured to:
receive the first message from the human interaction module; and
send a second message to the process orchestration module, wherein the second message includes second data that is based on the first data, and wherein the second data identifies the particular automated process and specifies one or more input parameters of the particular automated process; and
the process orchestration module is further configured to:
receive the second message from the event manager module; and
execute the particular automated process based on the second data included in the second message.

9. The system as recited in claim 1, further comprising an identity module configured at least to:
receive identification credentials from users that use one or more mashups while the one or more mashups are being executed at the system;
authenticate the users based on the identification credentials;
generate identity tokens for those users that are authenticated, wherein the identity tokens are presented when the users cause one or more of the human interaction module, the event manager module, and the process orchestration module to execute operations included in the one or more mashups; and
provide the identification credentials to external services that are accessed by the one or more mashups while the one or more mashups are being executed at the system.

10. The system as recited in claim 1, wherein:
the system further comprises an identity module configured at least to:
authenticate users that use the mashup while the mashup is being executed at the system; and
generate identity tokens for those users that are authenticated;
the human interaction module is further configured to:
receive a particular identity token that is associated with a particular user from whom the user input is received;
present the particular identity token to the identity module in order to verify that the particular user is permitted to provide the user input to the human interaction module; and
include the particular identity token within the first event;
the event manager module is further configured to:
receive the particular identity token within the first event from the human interaction module; and
send the particular identity token to the process orchestration module; and
the process orchestration module is further configured to present the particular identity token to the identity module in order to verify that the particular user is permitted to cause the particular automated process to be executed.

11. The system as recited in claim 1, wherein the system is configurable to allow multiple users to use the mashup as a Software as a Service (SaaS) service.

12. The system as recited in claim 1, further comprising a Software as a Service (SaaS) module configured at least to:
provide the human interaction module, the event manager module, and the process orchestration module as one or more SaaS services over a network.

13. The system as recited in claim 12, further comprising an identity module configured at least to:
authenticate users that use one or more mashups while the one or more mashups are being executed at the system;
generate identity tokens for those users that are authenticated;
receive one or more identity tokens from the one or more SaaS services; and
verify whether one or more users respectively associated with the one or more identity tokens are permitted to access and use the one or more SaaS services.

14. The system as recited in claim 1, wherein two or more of the human interaction module, the event manager module, and the process orchestration module are configured to execute on two or more different computer system hosts.

15. A computer-readable storage medium comprising one or more sequences of instructions for executing mashups which instructions, when executed by one or more processors, cause at least:
a human interaction module receiving user input while a human workflow included in a mashup is being executed;
in response to the user input, the human interaction module raising a first event that indicates that the human workflow has experienced a change;
an event manager module receiving the first event from the human interaction module;
based on the first event, the event manager module identifying a particular automated process from one or more automated processes that are included in the mashup;
the event manager module invoking a process orchestration module to execute the particular automated process based on the first event; and
the process orchestration module executing the particular automated process in response to being invoked by the event manager module.

16. A computer-implemented method for deploying mashups, the method comprising:
receiving a definition of a mashup, wherein the definition specifies:
a plurality of design elements that define a human workflow included in the mashup; and
one or more automated processes included in the mashup that are integrated with the plurality of design elements;
receiving configuration information that specifies one or more execution components that are operable to execute the human workflow and the one or more automated processes included in the mashup;
based on the definition of the mashup and on the configuration information, generating deployment information that binds each of the human workflow and the one or more automated processes to the one or more execution components for execution; and
deploying the mashup to the one or more execution components based at least on the deployment information.

17. The computer-implemented method as recited in claim 16, wherein:
the one or more execution components comprise one or more servers; and
the deployment information includes a mapping that associates operations in the human workflow and in the one or more automated processes with one or more network addresses of the one or more servers.

18. The computer-implemented method as recited in claim 16, wherein generating the deployment information further comprises one or more of:
compiling a set of code included in the definition to generate a corresponding set of executable code that can be executed by at least one of the one or more execution components; and
based on the definition, generating a script conforming to a scripting language, wherein the script can be executed by at least one of the one or more execution components.

19. The computer-implemented method as recited in claim 16, wherein the deployment information includes data which indicates that the one or more execution components are configured as any one of:
a Software as a Service (SaaS) execution environment that is operable to allow multiple users to simultaneously use the mashup as a SaaS service while the mashup is being executed; and
a dedicated execution environment that is operable to execute the mashup as a stand-alone application.

20. The computer-implemented method as recited in claim 16, wherein the deployment information comprises a set of XML files.

21. The computer-implemented method as recited in claim 16, wherein the definition of the mashup comprises a set of XML files that define one or more of:
role information that specifies roles of end users that will use the mashup when the mashup is executed;
event information that specifies one or more events that indicate changes experienced by the human workflow; and
map information that specifies one or more rules for determining, at runtime, which automated process is to be invoked in response to which event.

22. A computer-implemented method for designing mashups, the method comprising:
receiving first design information for a mashup, wherein the first design information specifies a plurality of design elements that define a human workflow in the mashup;
receiving second design information for the mashup, wherein the second design information specifies one or more automated processes in the mashup;
receiving third design information for the mashup, wherein the third design information specifies one or more events, wherein a particular event of the one or more events associates a particular design element, of the plurality of design elements that define the human workflow, with a particular automated process of the one or more automated processes; and
generating a definition of the mashup based on the first design information, the second design information, and the third design information;
wherein the definition of the mashup logically integrates the plurality of design elements with the one or more automated processes based on the one or more events.

23. The computer-implemented method as recited in claim 22, wherein the definition of the mashup does not bind the plurality of design elements, the one or more automated processes, and the one or more events to any pre-determined execution components that are operable to execute the mashup.

24. The computer-implemented method as recited in claim 22, wherein the third design information further comprises map information that specifies one or more rules for determining, at runtime during execution of the mashup, which specific operation from multiple operations, that are included in the human workflow and in the one or more automated processes, is to be executed in response to which specific event of the one or more events.

25. The computer-implemented method as recited in claim 22, wherein the third design information indicates that:
the particular event is to be raised in response to user input that is to be received through the particular design element; and
the particular automated process is to be invoked in response to the particular event.

26. The computer-implemented method as recited in claim 22, wherein the third design information indicates that:
the particular event is to be raised in response to output from the particular automated process; and
the particular design element is to be invoked in response to the particular event.

27. The computer-implemented method as recited in claim 22, wherein the definition of the mashup comprises a set of XML files.

28. The computer-implemented method as recited in claim 22, further comprising:
receiving fourth design information, wherein the fourth design information specifies roles of end users that will use the mashup when the mashup is executed;
wherein generating the definition of the mashup further comprises generating the definition based on the fourth design information.
